(19) United States
(12) Patent Application Publication
(10) Pub. No.: US 2003/0009847 A1
(43) Pub. Date: Jan. 16, 2003

(54) Luggage handle wrap

(76) Inventors: Donald E. Godshaw, Evanston, IL (US); Andrezj Redzisz, Wheelins, IL (US)

Correspondence Address: BANNER & WITCOFF, LTD., TEN SOUTH WACKER DRIVE, SUITE 3000, CHICAGO, IL, 60606, US

(21) Appl. No.: 09/902,304

(22) Filed: Jul. 10, 2001

(51) Int. Cl. E05B 1/00

(52) U.S. Cl. 16/110.1

(57) ABSTRACT

A molded luggage handle wrap comprises an elastomeric plate which folds in one-third increments over the luggage straps of a duffle and includes molded finger depressions in the middle third of the plate as well as a peripheral recessed edge for receipt of a stitched binding.

### BACKGROUND OF THE INVENTION

In a principal aspect the present invention relates to a luggage handle wrap especially adapted for use in combination with double carry handles for duffels and other luggage.

Duffle bags and other luggage often utilize a pair of carry handles or straps made from fabric or similar flexible material. Each handle is attached separately to a side of the duffle, for example. The handles are separate in order to permit access to a zipper opening in the top of the duffle or luggage item. To transport the duffle, one grips the two handles or straps simultaneously.

Such a handle construction often also includes a luggage handle wrap which is attached to one of the handles or straps and is designed to wrap around the second handle or strap in order to form a convenient means to grip the handles together for ease of carrying. The wrap may be detached from engagement with at least one the handle so as to enable the handles to be separated thereby permitting ease of access to the duffle or luggage item. Though such constructions have been available, there has remained the need for an improved luggage handle wrap having improved comfort and ease of assembly.

### SUMMARY OF THE INVENTION

Briefly the present invention comprises a luggage handle wrap attached to a first luggage strap cooperative with a second luggage strap. The handle wrap is formed from a molded, elastomeric, rectangular shaped, flexible plate having a topside with a peripheral recessed edge and a series of transverse parallel formed spaced depressions in the center of the plate. The plate is fastened along its center or medial portion to the first one of two luggage straps and may be flexibly fitted around the second luggage strap. The plate includes fasteners so that when the sides of the plate overlap they will bond one to the other to thereby secure the first luggage straps to the second strap.

Thus it is an object of the invention to provide an improved luggage handle wrap.

It is a further of the invention to provide a luggage handle wrap formed from a thin plate of elastomeric material having a rectangular shape and including a recessed edge about its periphery on the top side thereof and further including a series of depressions in the topside to facilitate manual gripping.

Another object of the invention is to provide a rectangular luggage handle wrap which may be attached on its underside to a first strap and which may be folded about a second strap to thereby secure the second strap to provide a handle.

These and other advantages and features of the invention will be set forth in the detailed description which follows.

### BRIEF DESCRIPTION OF THE DRAWING

In the detailed description that follows, reference will be made to the drawing comprised of the following figures:

FIG. 1 is a top plan view of the luggage handle wrap;

FIG. 2 is a side elevation view of the luggage handle wrap of FIG. 1;

FIG. 3 is a top plan view of the luggage handle wrap of FIG. 1 in combination with a luggage strap;

FIG. 4 is a bottom plan view of the luggage handle wrap and strap or webbing of FIG. 3; and

FIG. 5 is an isometric view of the luggage handle wrap of FIGS. 3 and 4 illustrating the manner of use of the wrap to hold and maintain first and second luggage straps.

### DESCRIPTION OF THE PREFERRED EMBODIMENT

Referring to the figures, the luggage handle wrap of the invention comprises a thin, electrometric plate 10 having a width dimension 12 and a length dimension 14. The width dimension 12 is in the range of 3 to 5 inches typically. The length dimension 14 is typically in the range of 3 to 6 inches.

The electrometric plate 10 is made from molded rubber having a thickness in the range of ⅛ to ¼ inch. The plate 10 includes a top side 16 and an underside or bottom side 18. The plate 10 further includes a recessed peripheral edge or land 20 having a width dimension in the range of ⅛ to ⅜ inches. Further the plate 10 includes a one-third middle or transverse medial section or strip 22 extending from one lateral side 24 to the second lateral side 26. The medial section 22 comprises approximately the middle one-third of the plate 10 and further includes at least three equally sized, spaced recesses or digit depressions 28, 30, 32, and 34. The depressions, 28, 30, 32, and 34 are for receipt of the fingers of a person and thus are generally concave depressions formed in the topside 16 of the plate 10. Depressions 28, 30, 32, and 34 are elliptically shaped having parallel, equally spaced major axes transverse to a longitudinal axis 45 of section 22.

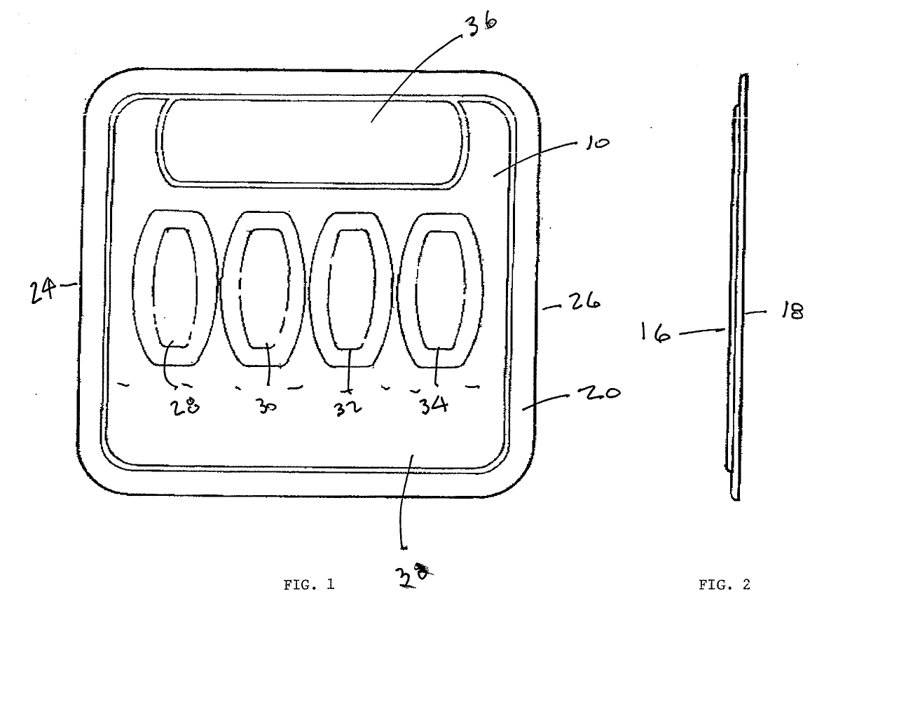

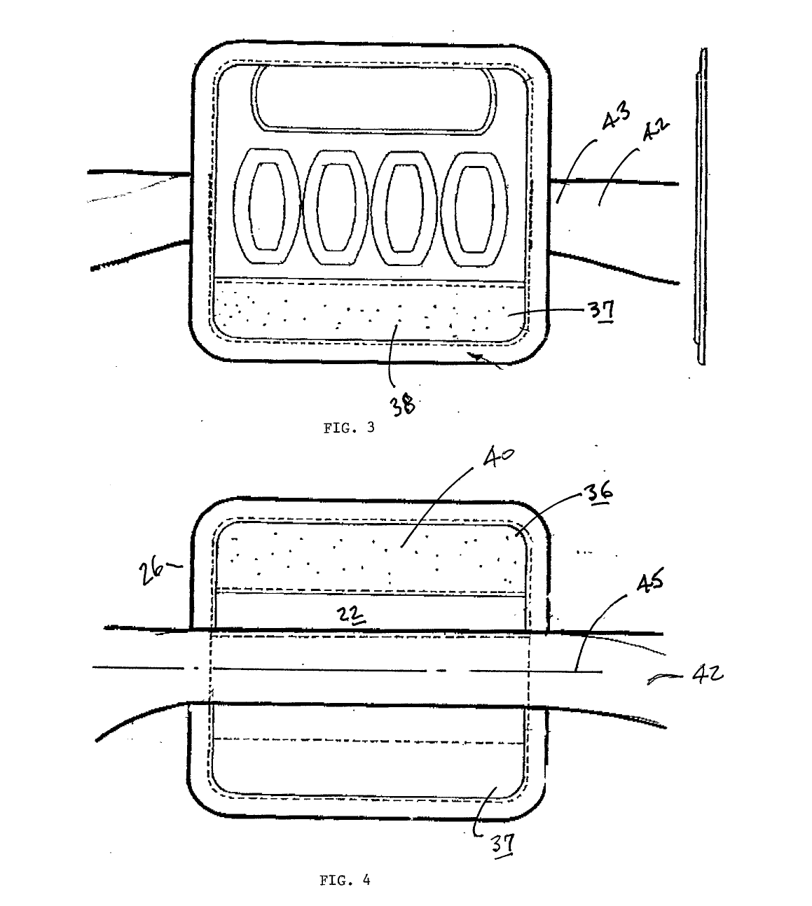

The plate 10 further includes a name plate or logo section or panel 36 defined on the top side 16 comprising about one-third of top side section 16 in FIG. 1. Instructions or a logo are positioned in this panel 36. Additionally referring to FIG. 1, the bottom one-third section 37 of the top side 16 includes a fastener material such as a Velcro fastener material 38. The fastener material 38 extends generally between the recesses associated with the lateral sides 24 and 26.

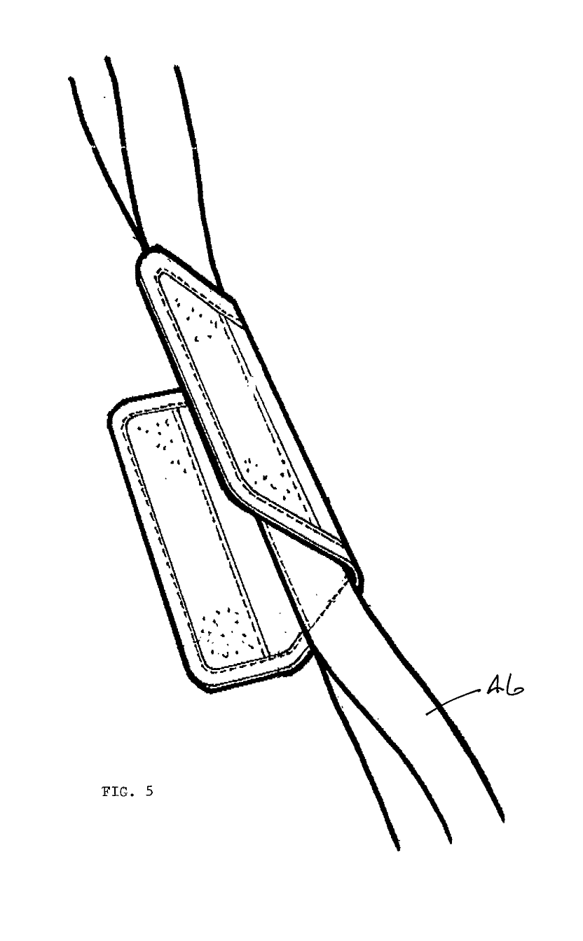

As shown in FIG. 4, the bottom side 18 of the plate 10 includes a fastener material 40 extending between the sides 24 and 26 on the side opposite panel 36. The underside 18 of medial center strip 22 is adapted for attachment to a luggage strap 42 by stitching, adhesive or other means. Thus handle webbing or strap 42 is attached to the underside 18 of the plate 10. A binding material 44 may be stitched or adhered to the plate 10 more particularly to the peripheral recess 20 for example by being top stitched. The top stitching binding 44 may also simultaneously effect retention of a lining material 46 on underside 38 such as a fabric lining material.

The strap or webbing 42 extends from the sides 24 and 26 of the plate 10 along a longitudinal axis 45 of the plate 10. As shown in FIG. 5, the plate 10 may then be folded approximately in one-third sections so that the outer ⅓ sections overlie each other and a second strap 46 thereby enabling the straps 42, 46 to be wrapped together. Thus the plate fastener material 40 will fold over and engage with the plate fastener material 38 to effectively couple the straps 42 and 46. Importantly the plate 10 is attached to the strap 42 to what would be typically referred to as the underside 43 of the strap 42 so that the depressions 28, 30, 32, and 34 are positioned to interact with the fingers when the folded plate 10 is fashioned about the webbing or straps 42, 46. This facilitates comfort when carrying the luggage item and further facilitates gripping.

It is possible to vary the features of the described invention without departing from the spirit and scope thereof. Alternative shapes of the depressions for the fingers, alternative dimensions of the plate 10, alternative fasteners 38, 40, and other alternative elements may be provided or added to the subject matter of the invention. Thus the invention is to be limited only by the following claims and equivalents thereof.

1. In luggage comprising a luggage handle wrap construction including first and second luggage straps each strap having a nominal width and a length, each strap having opposite ends attached to luggage, said straps aligned side by side for manual gripping to permit carriage of luggage, the improvement comprising, in combination:
a molded, elastomeric rectangular shaped flexible plate having a top side and an under side, a uniform thickness, a reduced thickness ledge circumscribing the perimeter of the top side, a medial center strip comprising substantially a medial one-third of the planar surface with a first lateral strip on one side of the medial center strip and a second lateral strip on the other side of the medial center strap, and at least three parallel, spaced, generally concave formed depressions in the medial center strip, each depression being oblong and defining an axis extending between the first and second lateral strips, said axes being generally parallel, said medial center strip sized for attachment of the underside thereof to one luggage strap with the lateral strips foldable one over the other and over the other luggage strap, and including fasteners on the underside of one lateral strap for attachment to a fastener on the top side of the other fastener strip;
a binding attached to the peripheral edge of the plate and fitted in the edge.

2. The luggage wrap construction of claim 1 in combination with first and second luggage straps, said plate underside being affixed to a strap along the medial center strip.
